(19) United States
(12) Patent Application Publication
(10) Pub. No.: US 2006/0085189 A1
(43) Pub. Date: Apr. 20, 2006

(54) Method and apparatus for server centric speaker authentication

(76) Inventors: Derek Dalrymple, Chicago, IL (US); Curtis Tuckey, Chicago, IL (US); Edward Bronson, Naperville, IL (US)

Correspondence Address: ORACLE INTERNATIONAL CORPORATION;c/o A. RICHARD PARK, 2820 FIFTH STREET, DAVIS, CA, 95616-2914, US

(21) Appl. No.: 10/966,084

(22) Filed: Oct. 15, 2004

(51) Int. Cl. G10L 17/00

(52) U.S. Cl. 704/250

(57) ABSTRACT

One embodiment of the present invention provides a system that facilitates authenticating voices at an application server. The system operates by first receiving a voice input generated by a user at the application server. The application server then retrieves a voice print matrix associated with the user from a database. Next, the system calculates a confidence value, which indicates a degree of match between the voice input and the voice print matrix. The system then performs an action based upon the confidence value.

### BACKGROUND

1. Field of the Invention

The present invention relates to mechanisms for performing voice authentication with computer systems. More specifically, the present invention relates to a method and an apparatus for server centric speaker authentication.

2. Related Art

Many modem computer applications can interact with a user through a voice gateway, which is situated between the user and an application running on an application server. Typically, the user establishes contact with the voice gateway through a telephone which is coupled to the public switched telephone network (PSTN). This voice gateway interacts with the user by executing instructions that are interpreted from a language such as the voice extensible markup language (VXML). This VXML is typically generated by an application server, which supplies it to a VXML interpreter inside the voice gateway for interpretation. The VXML interpreter can be thought of as an Internet browser.

The voice gateway typically includes an automated-speech-recognition (ASR) unit for interpreting the voice input from the user and a text-to-speech (TTS) unit for converting the prompt text in VXML to an audible output to present to the user.

In many situations, the application needs to verify the user's identity. In some cases, this verification can be in the form of a user identifier and password or personal identification number (PIN). However, such systems are easy to spoof and are not very secure. In more secure systems, other forms of verification of the user's identity are used, such as verifying the voice of a speaker.

In systems that perform speaker verification, the user begins by creating a voiceprint of his or her voice based on several “base” recordings. This voiceprint typically includes a matrix of numbers that uniquely describes the user's voice, but cannot be used to recreate the user's voice. During the verification process, the user supplies a voice sample to the system by saying a known phrase. This voice sample is then compared against the expected user's voiceprint and a value is returned. This returned value is a real value and not just the integers zero and one (no/yes). For example, the returned value can be a number between 0.0 and 1.0.

The application performing verification determines the threshold for acceptance or rejection. For example, if the score is above 0.9, the user can be accepted and if the score is below 0.6, the user can be rejected. If the score falls between the upper and lower thresholds, the user can be asked to say a second verification phrase and the process is repeated. The verification application can also perform recognition on the voice input to determine what the user said. This allows the system to determine if the user is actually speaking or if a recording is being used—this is known as knowledge verification.

The above-described system presents two problems for designers of voice applications. The first problem is that speaker verification can be performed only on specific voice gateways. The system designer may not be able to replace the voice gateway with one that provides speaker verification. The second problem is that the application typically has no control over the verification process. The system designer must accept the verification thresholds, which are supplied by the voice gateway.

Hence, what is needed is a method and an apparatus that facilitates verification of speakers without the problems described above.

### SUMMARY

One embodiment of the present invention provides a system that brokers the verification of voices through an application server. The system operates by first receiving a voice sample generated by a user and stored on the application server. The application server then retrieves a voice print matrix associated with the user from a database. Next, the system calculates a confidence value, which indicates a degree of match between the voice input and the voice print matrix. The system then performs an action based upon the confidence value.

In a variation of this embodiment, if the confidence value is above an upper threshold, the system accepts the user.

In a further variation, if the confidence value is below a lower threshold, the system does not authorize the user.

In a further variation, if the confidence value is between an upper threshold and a lower threshold, the user is asked to provide a second voice input.

In a further variation, if the confidence value is above a specified high value, the voice print matrix is updated using the latest voice sample.

In a further variation, the system verifies that the voice input includes a specified phrase.

In a further variation, the system establishes the voice print matrix from the user's voice during a training session.

In a further variation, the system calculates the confidence value in a verification engine that resides in another computing node, which is separate from the voice gateway, and operates under control of the application server.

### BRIEF DESCRIPTION OF THE FIGURES

FIG. 1 illustrates a server centric speaker verification system in accordance with an embodiment of the present invention.

FIG. 2 presents a flowchart illustrating the process of speech verification in accordance with an embodiment of the present invention.

FIG. 3 presents a flowchart illustrating the process of knowledge verification in accordance with an embodiment of the present invention.

FIG. 4 presents a flowchart illustrating the process of speaker enrollment in the voice recognition system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Speaker Authentication System

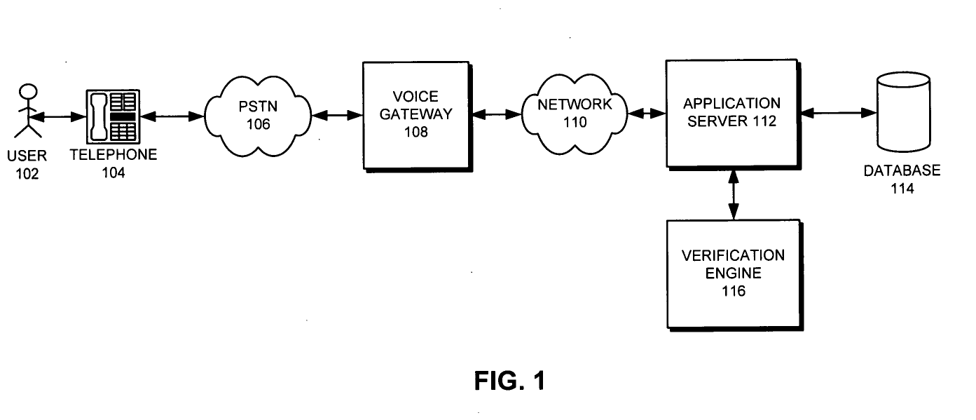

FIG. 1 illustrates a server centric speaker authentication system in accordance with an embodiment of the present invention. The server centric speaker verification system includes voice gateway 108, network 110, application server 112, database 114, and verification engine 116.

During operation, voice gateway 108 receives voice input from user 102 through telephone 104 and public switched telephone network (PSTN) 106. In order to process the voice input, voice gateway 108 accesses application server 112 across network 110 to retrieve voice extensible markup language (VXML) pages that specify interactions with user 102. Voice gateway 108 is coupled to application server 112 through network 110. Network 110 can generally include any type of wire or wireless communication channel capable of coupling together computing nodes. This includes, but is not limited to, a local area network, a wide area network, or a combination of networks. In one embodiment of the present invention, network 110 includes the Internet.

Voice gateway 108 interacts with user 102 and records the responses received from user 102 through telephone 104 via PSTN 106. These are well know functions of a voice gateway and will not be discussed further herein. The desired recorded utterance is forwarded to application server 112 across network 110.

Application server 112 can generally include any computational node including a mechanism for servicing requests from a client for computational and/or data storage resources. Application server 112 responds to voice gateway 108 with VXML pages, which may be stored in database 114. Database 114 can include any type of system for storing data in non-volatile storage. This includes, but is not limited to, systems based upon magnetic, optical, and magneto-optical storage devices, as well as storage devices based on flash memory and/or battery-backed up memory.

Application server 112 accepts the voice sample from user 102 from voice gateway 108 and provides the voice sample to verification engine 116 along with the voice print matrix associated with the identified user. Note that this voice print matrix can also be stored in database 114. Application server 112 can also provide the expected phrase or words that should be in the recorded voice response.

Verification engine 116 uses the voice sample and the voice print matrix to determine a confidence value indicating how closely the voice response matches the voice print matrix, in effect providing the confidence of how certain the system thinks the user is who they claim to be. Verification engine 116 can also determine if the correct words were spoken based upon the input from application server 112. Techniques used to calculate the confidence value and verify that the correct words were spoken are well-know in the art and will not be discussed further herein.

Verification engine 116 returns the confidence value and an indication of whether the correct words were spoken to application server 112. Application server 112 uses this information to accept or reject user 102 or to determine if a retry is necessary. If user 102 has not entered the correct words or if the confidence level is less than a given lower threshold, access is denied to user 102. If the confidence level is greater than a given upper threshold and the user has stated the appropriate phrase, user 102 is granted access to the requested application. If the confidence level is less than the upper threshold but greater than the lower threshold, user 102 may be asked to provide another voice input, possibly using a different pass phrase. If the confidence level is above an update threshold-typically higher than the upper threshold for authentication-the voice print matrix for user 102 can be updated with a new voice matrix generated from the voice sample and possibly the existing voice print matrix.

Verification engine 116 can also be used to enroll a new user into the system. In this mode, the new user is asked to provide several spoken phrases into the system. Verification engine 116 uses these spoken phrases to compute a voice print matrix for the new user. This voice print matrix can be subsequently stored in database 114.

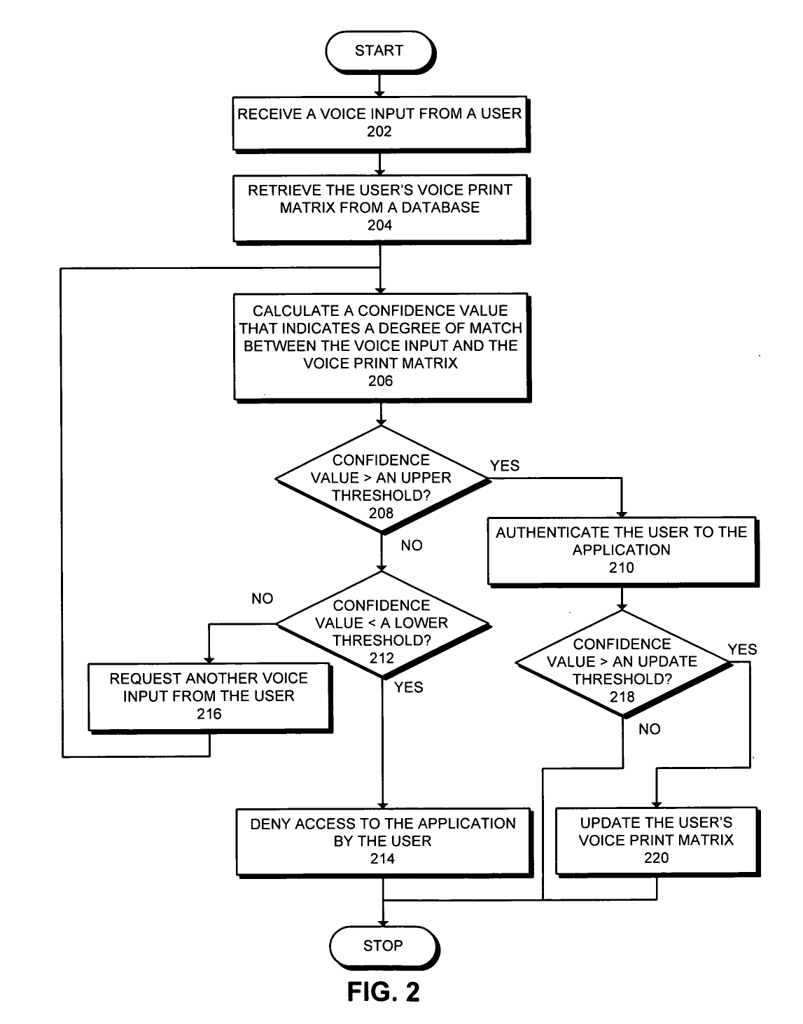

FIG. 2 presents a flowchart illustrating the process of speech verification in accordance with an embodiment of the present invention. The system starts when a voice input is received from a user (step 202). Next, the system retrieves the user's voice print matrix from the database (step 204).

The system then calculates a confidence value that indicates a degree of match between the voice input and the voice print matrix (step 206). Next, the system determines if the confidence value is greater than an upper threshold (step 208). If the confidence value is greater than the upper threshold at step 208, the user is authenticated to the application (step 210). If not, the system determines if the confidence value is less than a lower threshold (step 212). If so, the system denies access to the application by the user (step 214). If the confidence value is not less than the lower threshold at step 212, the user is asked to provide another voice input (step 216). The process then returns to step 206 to process a new voice input from the user.

After granting access to the application, the system also determines if the confidence value is greater than an update threshold (step 218). If so, the system updates the user's voice print matrix with a new voice print matrix generated with the voice sample and possibly the existing voice print matrix (in this way, the system maintains a current voice matrix for the user, which allows the user's voice to evolve over time) (step 220). Otherwise, the process is terminated.

Knowledge Verification

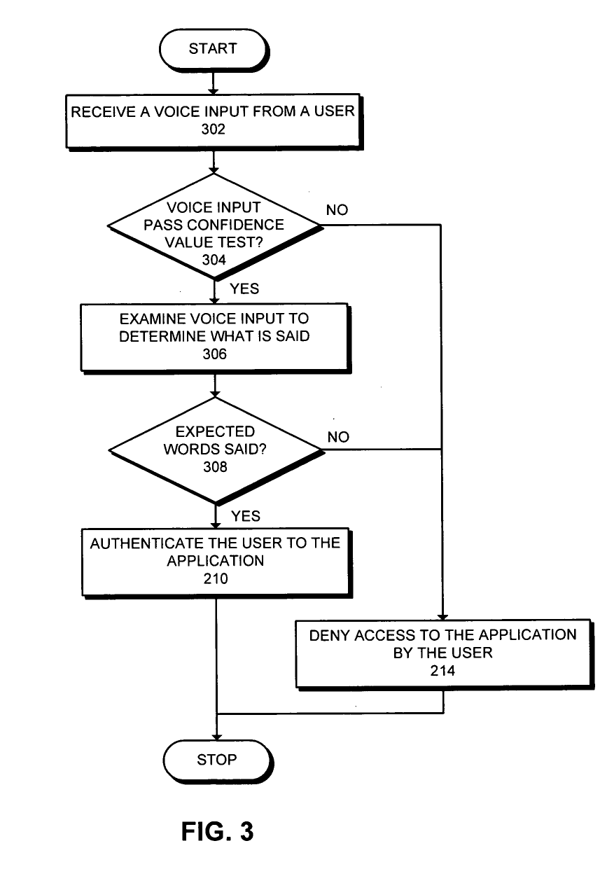

FIG. 3 presents a flowchart illustrating the process of knowledge verification in accordance with an embodiment of the present invention. The system starts when a voice input is received from a user (step 302). Next, the system determines if the voice input passes a confidence value test (step 304). The process of determining if the voice input passes the confidence value test is described in detail above in conjunction with FIG. 2.

If the audio input passes the confidence value test, the system examines the voice input to determine what is said (step 306). Next, the system determines if the expected words are said (step 308). If so, the system authenticates the user to the application (step 210). If the voice input does not pass at step 304 or if the expected words were not said at step 308, the system denies access to the application by the user (step 214).

Note that the system can alternatively determine if the proper words were spoken before the speaker is verified or in parallel with the verification. In this case, if the proper words are not spoken, the system may not perform the speaker verification steps. Knowledge verification is well known in the art and will not be discussed further herein.

Speaker Enrollment

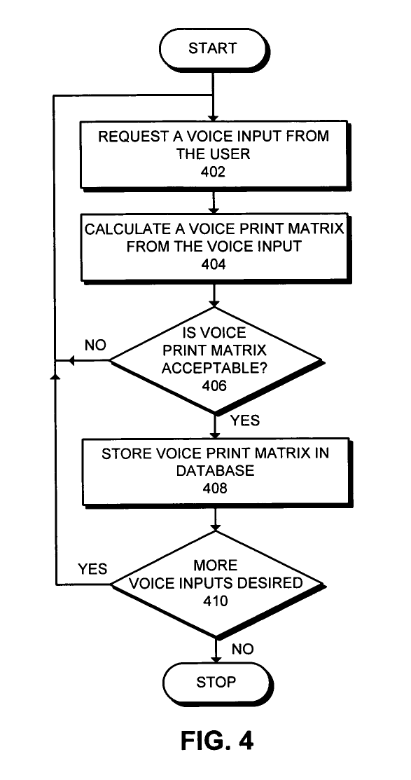

FIG. 4 presents a flowchart illustrating the process of speaker enrollment in the voice recognition system in accordance with an embodiment of the present invention. The system starts when the system requests a voice input from the user (step 402). Next, the system calculates a voice print matrix from the voice input (step 404).

The system then determines if the voice print matrix is acceptable for determining the speaker's voice (step 406). This determination can be based upon the amount of change from a previous voice print matrix. If a previous voice print matrix does not exist, then the new one is used. The system can optionally ask the user to supply several voice input samples to create a more accurate voice print matrix. If the voice print matrix is acceptable, the system stores the voice print matrix in the database (step 408). If the voice print matrix is not acceptable, the system returns to step 402 to continue gathering input. After storing the voice print matrix in the database, the system determines if more voice inputs are desired (step 410). If so, the system returns to step 402 to continue gathering input. Otherwise, the process is terminated.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for authenticating voices at an application server, comprising:
receiving a voice input generated by a user at the application server;
retrieving a voice print matrix associated with the user from a database;
calculating a confidence value, wherein the confidence value indicates a degree of match between the voice input and the voice print matrix; and
performing an action based upon the confidence value.

2. The method of claim 1, wherein if the confidence value is above an upper threshold, the method further comprises authenticating the user to the application server.

3. The method of claim 1, wherein if the confidence value is below a lower threshold, the method further comprises not authenticating the user to the application server.

4. The method of claim 1, wherein if the confidence value is between an upper threshold and a lower threshold, the user is asked to enter a second voice input.

5. The method of claim 1, wherein if the confidence value is above a specified high value, the voice print matrix is updated from the voice input.

6. The method of claim 1, further comprising verifying that the voice input includes a specified verbalism, wherein verifying that the voice input includes a specified verbalism can be done in parallel with calculating the confidence value.

7. The method of claim 1, further comprising establishing the voice print matrix from the user's voice during a training session.

8. The method of claim 1, wherein operations involved in calculating the confidence value are performed in a verification engine that resides in another computing node, which is separate from the voice gateway, and operates under control of the application server.

9. A computer-readable storage medium storing instructions that when executed by a computer cause the computer to perform a method for verifying voices at an application server, the method comprising:
receiving a voice input generated by a user at the application server;
retrieving a voice print matrix associated with the user from a database;
calculating a confidence value, wherein the confidence value indicates a degree of match between the voice input and the voice print matrix; and
performing an action based upon the confidence value.

10. The computer-readable storage medium of claim 9, wherein if the confidence value is above an upper threshold, the method further comprises authenticating the user to the application server.

11. The computer-readable storage medium of claim 9, wherein if the confidence value is below a lower threshold, the method further comprises not authenticating the user to the application server.

12. The computer-readable storage medium of claim 9, wherein if the confidence value is between an upper threshold and a lower threshold, the user is asked to enter a second voice input.

13. The computer-readable storage medium of claim 9, wherein if the confidence value is above a specified high value, the voice print matrix is updated from the voice input.

14. The computer-readable storage medium of claim 9, the method further comprising verifying that the voice input includes a specified verbalism, wherein verifying that the voice input includes a sp0ecified verbalism can be done in parallel with calculating the confidence value.

15. The computer-readable storage medium of claim 9, the method further comprising establishing the voice print matrix from the user's voice during a training session.

16. The computer-readable storage medium of claim 9, wherein operations involved in calculating the confidence value are performed in a verification engine that resides in another computing node, which is separate from the voice gateway, and operates under control of the application server.

17. An apparatus for verifying voices at an application server, comprising:
a receiving mechanism configured to receive a voice input generated by a user from a voice gateway at the application server;
a retrieving mechanism configured to retrieve a voice print matrix associated with the user from a database;
a calculating mechanism configured to calculate a confidence value, wherein the confidence value indicates a degree of match between the voice input and the voice print matrix; and
a performing mechanism configured to perform an action based upon the confidence value.

18. The apparatus of claim 17, further comprising an authentication mechanism configured to authenticate the user to the application server if the confidence value is above an upper threshold.

19. The apparatus of claim 18, wherein the authentication mechanism is further configured to not authenticate the user to the application server if the confidence value is below a lower threshold.

20. The apparatus of claim 18, wherein the authentication mechanism is further configured to ask the user to enter a second voice input if the confidence value is between the upper threshold and a lower threshold.

21. The apparatus of claim 17, further comprising an updating mechanism configured to update the voice print matrix from the voice input if the confidence value is above a specified high value.

22. The apparatus of claim 17, further comprising a verifying mechanism configured to verify that the voice input includes a specified verbalism, wherein verifying that the voice input includes a sp0ecified verbalism can be done in parallel with calculating the confidence value.

23. The apparatus of claim 17, further comprising an initializing mechanism that is configured to establish the voice print matrix from the user's voice during a training session.

24. The apparatus of claim 17, wherein operations involved in calculating the confidence value are performed in a verification engine that resides in another computing node, which is separate from the voice gateway, and operates under control of the application server.
